(19) United States
(12) Patent Application Publication
(10) Pub. No.: US 2011/0279755 A1
(43) Pub. Date: Nov. 17, 2011

(54) LIQUID CRYSTAL DISPLAY DEVICE AND GAME DEVICE

(75) Inventor: Eiji Nittou, Osaka-shi (JP)

(73) Assignee: SHARP KABUSHIKI KAISHA, Osaka-shi, Osaka (JP)

(21) Appl. No.: 13/146,215

(22) PCT Filed: Sep. 28, 2009
(86) PCT No.: PCT/JP2009/066724

§ 371 Date: Jul. 26, 2011

(30) Foreign Application Priority Data
Feb. 23, 2009 (JP) 2009-038830

(51) Int. Cl. G02F 1/1347

(52) U.S. Cl. 349/77

(57) ABSTRACT

A curved surface (CS) is formed by chamfering on a light guide plate (11) portion which overlaps with an outer edge (SD) of a liquid crystal shutter (21).

### TECHNICAL FIELD

The present invention is related to a liquid crystal display device (a display device) and a game device incorporating the liquid crystal display device.

### BACKGROUND ART

As disclosed in Patent Literature 1, for example, there has been a conventional technology for realizing a large-screen liquid crystal display device by assembling modules (liquid crystal display modules) each including a liquid crystal display panel. However, there is a problem in this technology. That is, when a plurality of liquid crystal display modules are arranged side by side, boundary regions between the liquid crystal display modules, which is not able to display anything, are conspicuous to a viewer.

These days, as disclosed in Patent Literature 2, there has also been a technology that uses a liquid crystal display module as a shutter (a liquid crystal shutter) by using a liquid crystal layer that is switchable between a light transmitting state and a light scattering state in the liquid crystal module. With this technology, referring to the technology of Patent Literature 1, it is also possible to assemble these liquid crystal shutters to produce a large-screen shutter unit (a liquid crystal shutter unit).

### CITATION LIST

### Patent Literature

Patent Literature 1: JP-A-2000-258792
Patent Literature 2: JP-A-2005-185624

### SUMMARY OF INVENTION

### Technical Problem

Now, as in a typical liquid crystal panel, in a liquid crystal shutter, a liquid crystal layer is placed between a pair of light transmitting substrates, and the peripheries of the light transmitting substrates are sealed with a sealing agent to thereby seal the liquid crystal layer between the substrates. As a result, a liquid crystal shutter includes the sealing agent that does not have a shutter function. Then, when a liquid crystal shutter unit including a plurality of liquid crystal shutter is completed and the liquid crystal shutter unit is incorporated in a liquid crystal display device, the device may suffer from the same problem as in Patent Literature 1.

That is, when the liquid crystal shutters are arranged side by side in the liquid crystal shutter unit, the sealing agents, which are visible, are located along the peripheries of the liquid crystal shutters, which will be undesirably noticeable to an external viewer.

The present invention has been made to solve the above problems. And, an object of the present invention is to provide a liquid crystal display device and the like in which a visible member such as a sealing agent included in a liquid crystal shutter is less noticeable.

### Solution to Problem

To achieve the above object, according to one aspect of the present invention, a liquid crystal display device includes: a liquid crystal display module which is not only capable of displaying an image but also switchable to a light transmission screen; and a liquid crystal shutter unit which switches between states for allowing and blocking external visibility through the light transmission screen. Here, in this liquid crystal display device, the liquid crystal shutter unit is an assembly formed planar by arranging a plurality of liquid crystal shutters in a plane, the liquid crystal shutters each having liquid crystal sealed therein with a sealing agent. Furthermore, at one surface side of the liquid crystal shutter unit which is planar, a light transmitting substrate is arranged to overlap the liquid crystal shutter unit, and in the light transmitting substrate, at a portion thereof overlapping the sealing agent which is located at a periphery of each of the liquid crystal shutters, there is formed a curved surface that makes the sealing agent look narrower than the sealing agent actually is when the sealing agent is seen through the curved surface.

With this structure, when the liquid crystal display module is switched to be a light transmission screen and the liquid crystal shutter unit is visually recognized externally via the light transmission screen, the light transmitting substrate is also visually recognized as well as the liquid crystal shutter unit. In this case, the curved surfaces included in the light transmitting substrate overlap the sealing agents located at the peripheries of the liquid crystal shutters.

The curved surface refracts the optical image of the sealing agent to thereby make the sealing agent, which is seen through the curved surface, look narrower than it actually is. This makes the sealing agent look comparatively small when it is seen by an external viewer. As a result, in the thus-structured liquid crystal display device, the sealing agent included in the liquid crystal shutter unit is prevented from becoming undesirably noticeable.

Incidentally, there is no particular limitation to the arrangement of the light transmitting substrate, the liquid crystal display module, and the liquid crystal shutter unit, and for example, the light transmitting substrate may be placed between the liquid crystal display module and the liquid crystal shutter unit. Also, the light transmitting substrate may cover the liquid crystal display module that covers the liquid crystal shutter unit.

Further, in the liquid crystal display device, the liquid crystal shutter unit may include a void region formed by arranging the liquid crystal shutters leaving a void space corresponding to part of one surface of the light transmitting substrate, and there may be further included a light source that supplies light to the liquid crystal display module through the void region.

With this structure, the liquid crystal display module further receives light from the light source to perform a highly bright image display therewith.

The present invention also includes a game device including: the liquid crystal display device described above; and a pattern portion that is externally visible through the liquid crystal display module and the liquid crystal shutter unit when the liquid crystal display module is switched to be the light transmission screen and the liquid crystal shutter unit obtains external visibility.

### Advantageous Effects of Invention

According to the present invention, as a result of the inclusion of the curved surfaces in the light transmitting substrate so as to cover the sealing agents, the optical images of the sealing agents shown on the curved surfaces look smaller than they actually are. This helps prevent the sealing agents from becoming undesirably noticeable to an external viewer.

### BRIEF DESCRIPTION OF DRAWINGS

FIG. 1 An exploded perspective view showing a liquid crystal display device and a pattern plate;

FIG. 2 A plan view of a pattern plate;

FIG. 3 An exploded perspective view of a liquid crystal display module included in a liquid crystal display device;

FIG. 4 A plan view of a liquid crystal shutter unit;

FIG. 5 A three-view diagram showing, in combination, a plan view and two side views concerning a light guide plate for use in a liquid crystal shutter unit;

FIG. 6 A sectional view of the liquid crystal display device and the pattern plate shown in FIG. 1;

FIG. 7 A partially enlarged view of FIG. 6;

FIG. 8 A plan view showing the pattern plate as viewed through the liquid crystal display panel shown in FIG. 6;

FIG. 9 A sectional view showing a liquid crystal display device of a comparative example which is different from the liquid crystal display device shown in FIG. 6 and the pattern plate;

FIG. 10 A partially enlarged view of FIG. 9;

FIG. 11A plan view showing the pattern plate as viewed through the liquid crystal display panel shown in FIG. 9;

FIG. 12 A plan view showing an image displayed on a liquid crystal display panel when a liquid crystal shutter unit in a liquid crystal display device is in a CLOSE state;

FIG. 13 A plan view showing the pattern plate as viewed through the liquid crystal display panel (another example related to FIG. 8);

FIG. 14 An exploded perspective view showing a liquid crystal display device and a pattern plate different from those shown in FIG. 1; and

FIG. 15 An exploded perspective view showing a liquid crystal display device and a pattern plate different from those shown in FIGS. 1 and 14.

### DESCRIPTION OF EMBODIMENTS

Hereinafter, an embodiment of the present invention will be described based on the drawings. Hatching, reference signs for members and the like may sometimes be omitted in a drawing for ease of description, and in such a case, a different drawing is to be referred to. Reversely, views other than sectional views may be shown with hatching for the sake of convenience. A black dot in a drawing indicates a direction perpendicular to the sheet on which the drawing is drawn.

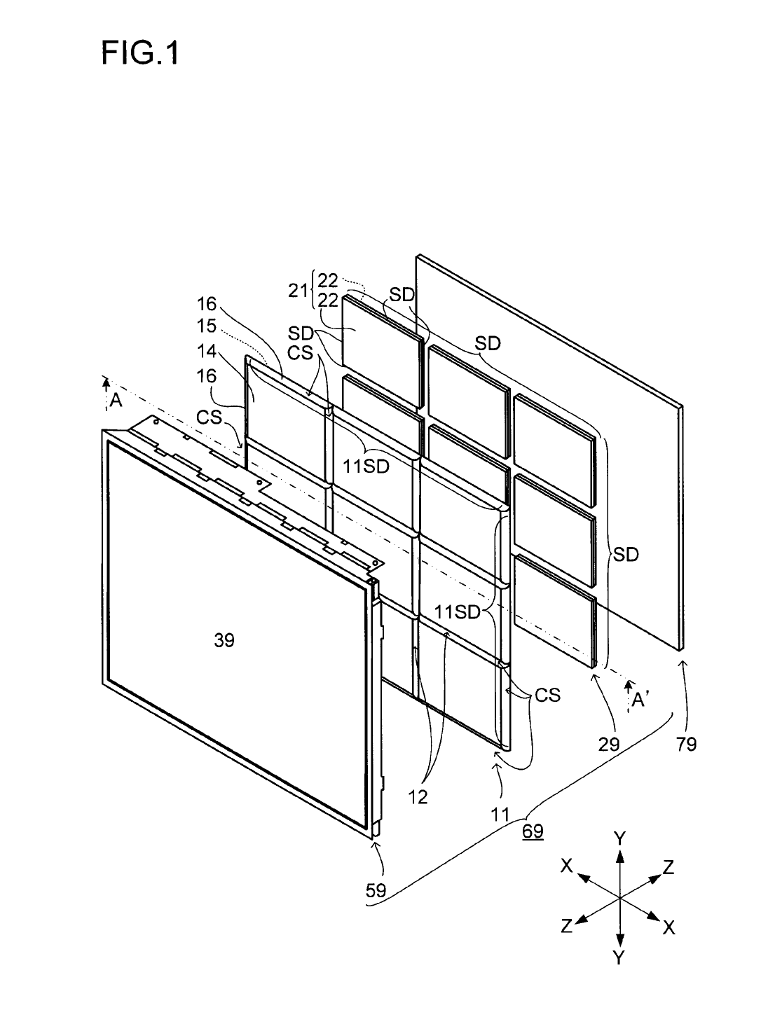

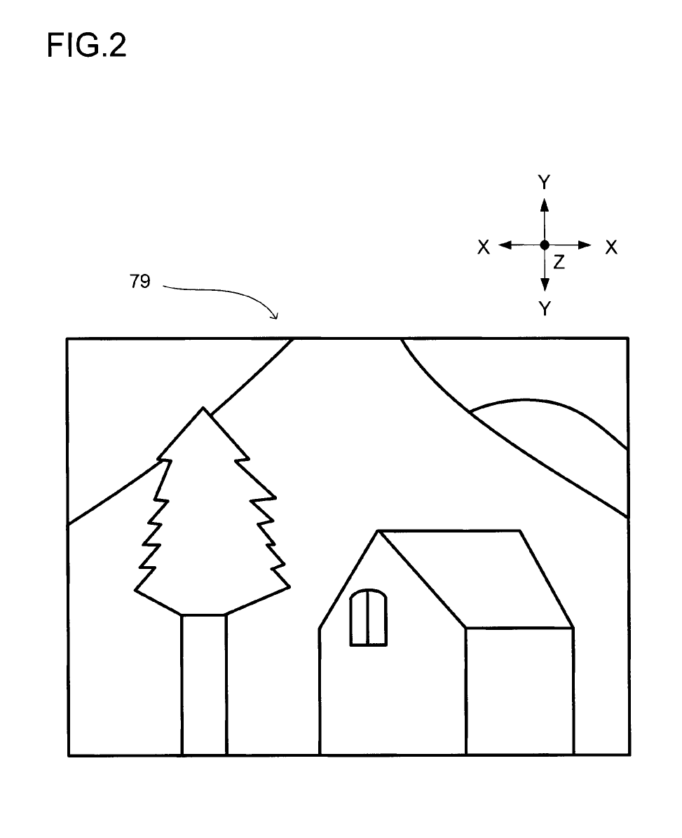

Game devices of late such as slot machines and a pachinko machines incorporate a display device such as a liquid crystal display device. Such a liquid crystal display device and a pattern plate (a pattern portion) incorporated in a game device are shown in FIG. 1. As shown in FIG. 1, the liquid crystal display device 69 includes a liquid crystal display module 59, a liquid crystal shutter unit 29, and a light guide plate (a light transmitting substrate) 11. And, the liquid crystal display device 69 covers the pattern plate 79 with the liquid crystal shutter unit 29 facing the pattern plate 79 (incidentally, a plan view of the pattern plate 79 is shown in FIG. 2).

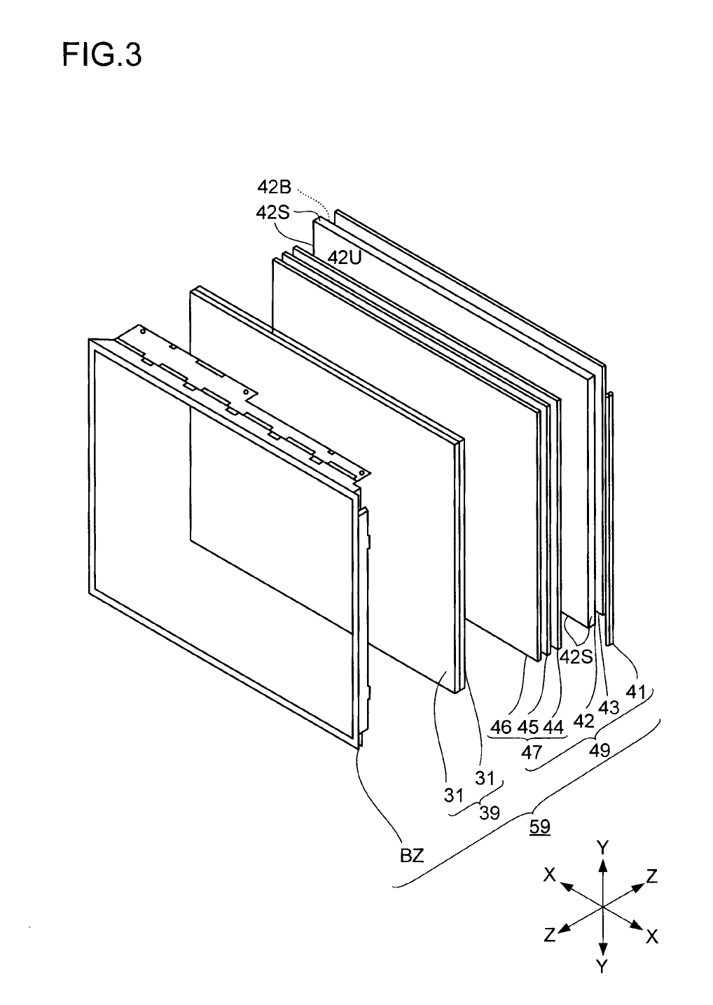

As shown in FIG. 3, the liquid crystal display module 59 includes a light transmitting or semi-light-transmitting liquid crystal display panel 39, a backlight unit 49 that supplies light to the liquid crystal display panel 39, and a bezel BZ that accommodates the liquid crystal display panel 39 and the backlight unit 49.

The liquid crystal display panel 39 includes a liquid crystal layer (unillustrated) sealed between a pair of transparent substrates 31•31 having electrodes (unillustrated), and the liquid crystal display panel 39 is capable of displaying an image by controlling the behavior of liquid crystal molecules in the liquid crystal layer by means of voltage applied between the electrodes. Needless to say, the liquid crystal display panel 39 can be switched to be a light transmission screen depending on the behavior of the liquid crystal molecules. Thus, it can be said that the liquid crystal display module 59 is not only capable of displaying an image but also switchable to a light transmission screen (incidentally, the long-side direction of the liquid crystal display panel 39, the short-side direction of the liquid crystal display panel 39, and the overlap direction of the transparent substrates 31•31 will be referred to as an X direction, a Y direction, and a Z direction, respectively).

The backlight unit 49 includes a fluorescent tube 41, a light guide plate 42, a reflection sheet 43, and an optical sheet group 47.

The fluorescent tube 41 emits light and functions as a light source. The fluorescent tube 41, however, emits linear light, and thus it is difficult to deliver light all over the liquid crystal display panel 39. To cope with this, the backlight unit 49 is provided with the light guide plate 42, which converts linear light to planar light by performing multiple reflection of linear light.

The light guide plate 42, which is plate-shaped, receives light from the fluorescent tube 41 at a side surface 42S thereof, repeatedly reflects the light therein, and thereby outputs planar light from a wide top surface 42U thereof (so-called edge light method). Incidentally, a reflection sheet 43 is provided for the purpose of preventing leakage of light through surfaces of the light guide plate 42 other than the top surface 42U, that is, for example, through a bottom surface 42B which is opposite from the top surface 42U.

The reflection sheet 43 is covered with the bottom surface 42B of the light guide plate 42, and reflects light coming from the bottom surface 42B to thereby return the light back into the light guide plate 42. However, the reflection sheet 43 does not have a complete reflection surface, but is equipped with light transmitting characteristic as well.

The optical sheet group 47 includes a diffusion sheet 44 and prism sheets 45•46. The diffusion sheet 44 is located to cover the top surface 42U of the light guide plate 42, and diffuses the planar light from the light guide plate 42 to deliver light all over the liquid crystal display panel 39.

The prism sheets 45•46 are optical sheets each having a prism-like shape on its sheet surface and deflect the radiation characteristic of light, and they are placed so as to cover the diffusion sheet 44. As a result, the optical sheets 45•46 collect light travelling thereto from the diffusion sheet 44, and this helps achieve improved brightness.

And, in the backlight unit 49 structured as described above, light from the fluorescent tube 41 passes through the light guide plate 42 to be thereby converted to, and outputted therefrom, as planar light, and then passes through the optical sheet group 47 to be outputted as backlight light having enhanced emission brightness. Then, this backlight light reaches the liquid crystal display panel 39, and the liquid crystal display panel 39 displays an image by means of the backlight light.

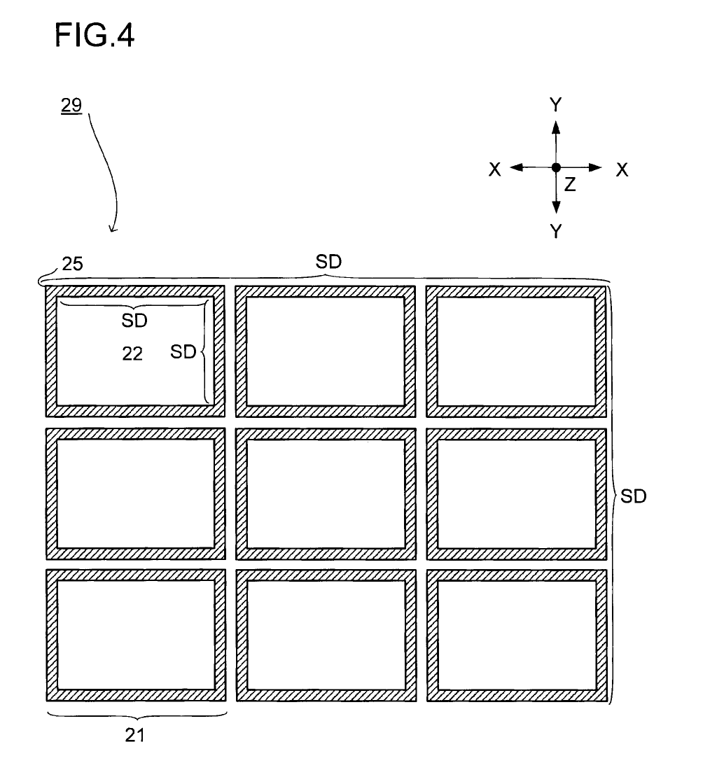

As shown in FIGS. 1 and 4, the liquid crystal shutter unit 29 is formed with a plurality of liquid crystal shutters 21 arranged in matrix (incidentally, the external shape of the liquid crystal shutter unit 29, forming a plane by matrix arrangement, is approximately the same as that of the liquid crystal display panel 39). In each of the liquid crystal shutters 21, a liquid crystal layer 23 is sealed between a pair of transparent substrates 22•22 including electrodes (unillustrated) (see FIG. 7, which will be referred to later). And, the liquid crystal shutter 21 controls the behavior of the liquid crystal layer 23 by means of voltage applied between the electrodes.

For example, when the voltage applied between the electrodes is increased, the liquid crystal molecules included in the liquid crystal layer 23 (for example, a polymer dispersed liquid crystal layer) are aligned along the thickness direction of the liquid crystal layer (the same direction as the Z direction), to allow easy transmission of external light therethrough. Thus, this state will be referred to as a state (OPEN) in which the liquid crystal shutter unit 29 is opened.

On the other hand, when the voltage applied between the electrodes is reduced, the liquid crystal molecules included in the liquid crystal layer are aligned in a direction perpendicular to the thickness direction of the liquid crystal layer 23, to scatter external light (in short, the liquid crystal layer 23 inside the liquid crystal shutter 21 is turned to milky turbid state to transmit less external light). Thus, this state will be referred to as a state (CLOSE) in which the liquid crystal shutter unit 29 is closed.

Incidentally, in the space between the transparent substrates 22•22 in which the liquid crystal layer 23 are held, along the periphery SD of the liquid crystal shutter 21, a sealing agent 25 for sealing the liquid crystal layer 23 is placed, such that part of the sealing agent is exposed from the peripheries SD of the transparent substrates 22•22 (see the hatching part of FIG. 4). For example, the sealing agent 25 is exposed about 5 mm from the peripheries SD of the transparent substrates 22•22. And, the sealing agent 25, which is not part of the liquid crystal layer 23, does not have a light transmitting function.

Thus, when a plurality of liquid crystal shutters 21 are arranged in matrix, non-light-transmitting sealing agents 25 are located between the liquid crystal shutters 21•21, and close to part of the peripheries SD of outermost ones of the liquid crystal shutters 21 that forms the periphery SD of the liquid crystal shutter unit 29. As a result, the sealing agents 25 are externally visible (that is, when a viewer looks at an image displayed on the liquid crystal display device 69, the sealing agents 25 are annoyingly noticeable to the viewer).

The light guide plate 11 is formed of a light-transmitting material (for example, acrylic resin) like the light guide plate 42 incorporated in the liquid crystal display module 59. And, the outer shape of the light guide plate 11, which transmits light, is approximately the same as that of the liquid crystal display panel 39 and that of the liquid crystal shutter unit 29.

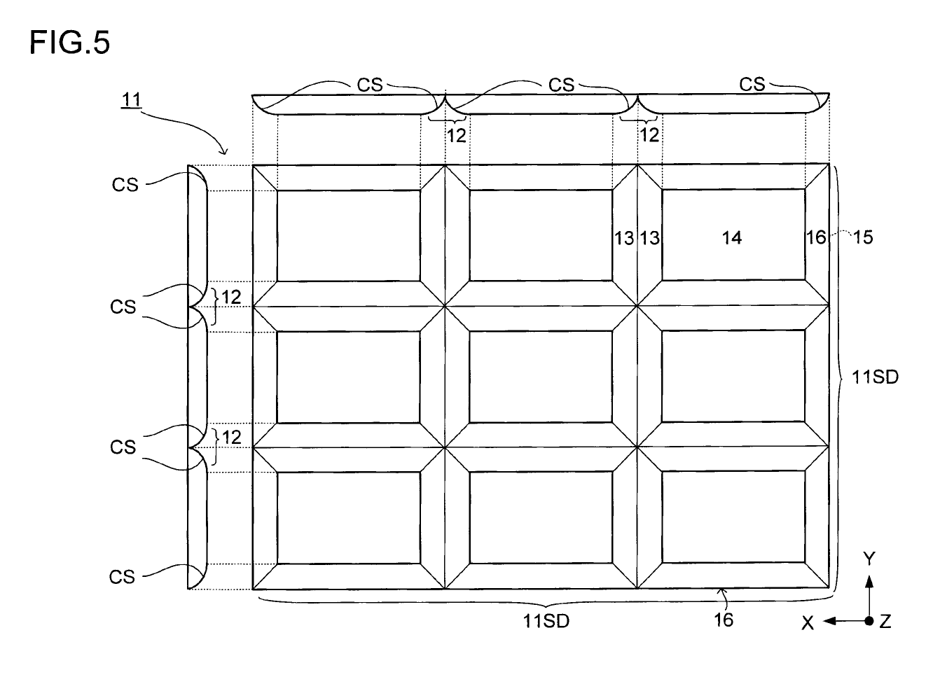

However, as shown in the three-view diagram of FIG. 5 (plan view and two side views), the light guide plate 11 has cuts 12 formed in its surface. More specifically, the cuts 12 are located in the surface of the light guide plate 11 to cover the sealing agents 21 included in the liquid crystal shutter unit 29 when the light guide plate 11 is placed to cover the liquid crystal shutter unit 29. Thus, when rectangular liquid crystal shutters 21 are arranged in matrix, the cuts 12 form a lattice.

And, as shown in FIG. 5, rounding processing is applied to the cuts 12 such that corners between inner surfaces 13 of the cuts 12 and a top surface 14 (a surface 14 that, in the light guide plate 42, faces the viewer) of the light guide plate 11 are rounded into curved surfaces CS {incidentally, the center of curvature of any of the curved surfaces CS is located at the bottom surface 15 (a surface opposite from the top surface 14) side with respect to the curved surface CS, and thus the curved surface CS protrudes outward}.

Besides, the rounding processing is also applied to periphery 11SD of the light guide plate 11 that covers the periphery SD of the liquid crystal shutter unit 29 (that is, parts of the peripheries SD of the liquid crystal shutters 21 that are not located to face each other). Specifically, through such rounding processing, as shown in FIG. 5, corners between the top surface 14 and the side surfaces 16 of the light guide plate 11 are rounded into curved surfaces CS (incidentally, the center of curvature of any of these curved surfaces CS is also located at the bottom surface 15 side with respect to the curved surface CS, and thus the curved surface CS is externally raised.

That is, the curved surfaces CS are formed by the rounding processing at the parts of the light guide plate 11 that overlap the peripheries SD of the liquid crystal shutters 21 (more specifically, in the liquid crystal shutter unit 29, part of the peripheries SD of any adjacent ones of the liquid crystal shutters 21 that is located between the adjacent ones of the liquid crystal shutters 21, and part of the peripheries of the liquid crystal shutters 21 that forms the periphery SD of the liquid crystal shutter unit 29).

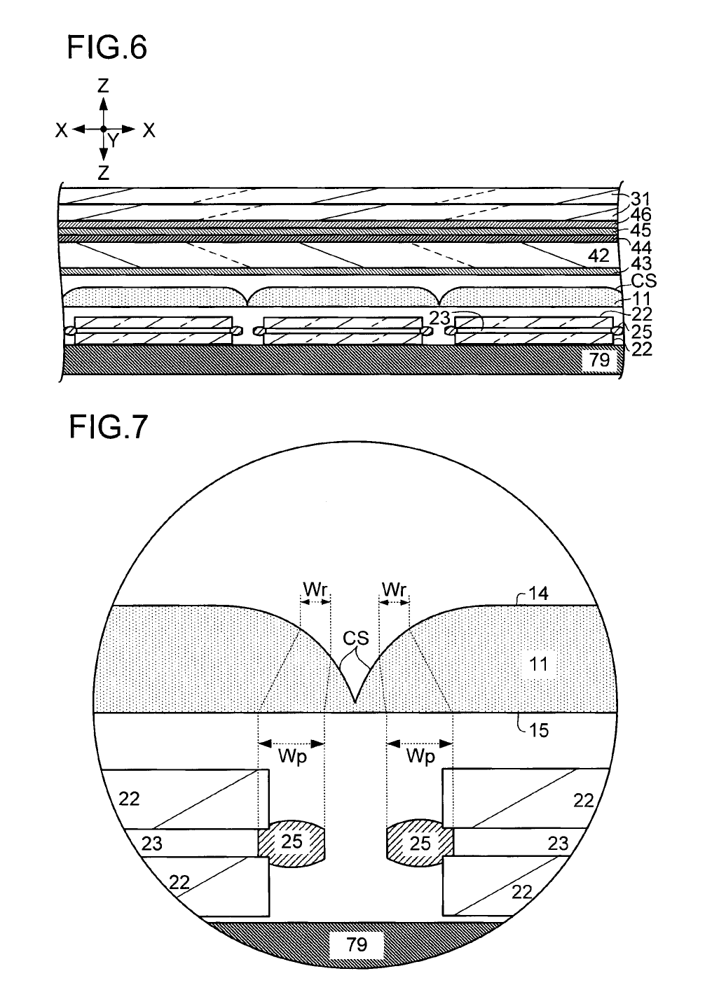

And, in a game device incorporating the liquid crystal display device 69 including the light guide plate 11 having the curved surfaces CS (that is, a game device including the liquid crystal display device 69 and the pattern plate 79 that is externally visible through the liquid crystal display module 59 and the liquid crystal shutter unit 29 when the liquid crystal display module is switched to be the light transmission screen and the liquid crystal shutter unit obtains external visibility), the following phenomenon is observed. The phenomenon will be described with reference to FIGS. 6 to 11.

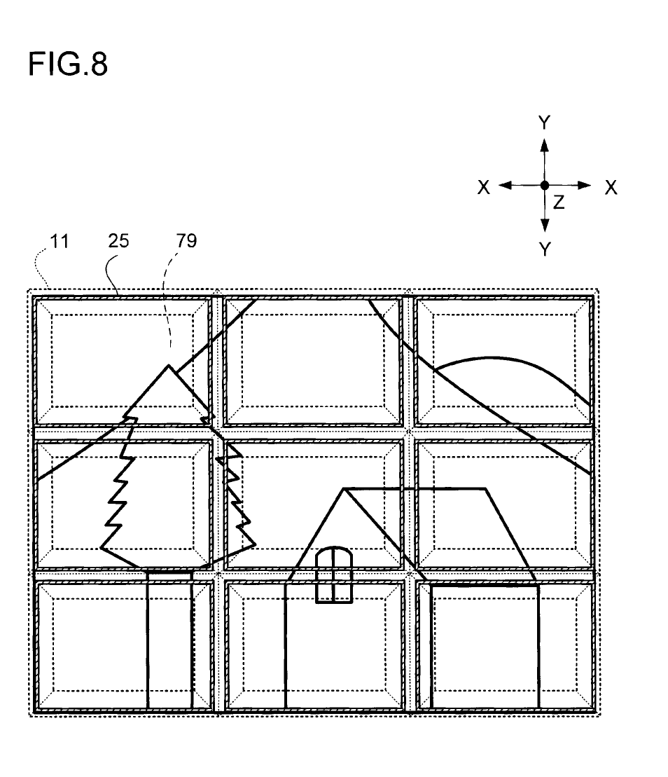

FIG. 6 is a sectional view of a liquid crystal display device 69 incorporating a light guide plate 11 (taken along line A-A′ of FIG. 1 and viewed in the direction of the arrows in FIG. 1), and FIG. 7 is an enlarged view of FIG. 6. And, FIG. 8 is a plan view showing the pattern plate 79 that is visible through the liquid crystal display panel 39 of the liquid crystal display device 69 shown in FIG. 6 (that is, visible when the liquid crystal display module 59 is switched to be a light transmission screen). Incidentally, for the sake of convenience, the light guide plate 11 is illustrated with dotted lines.

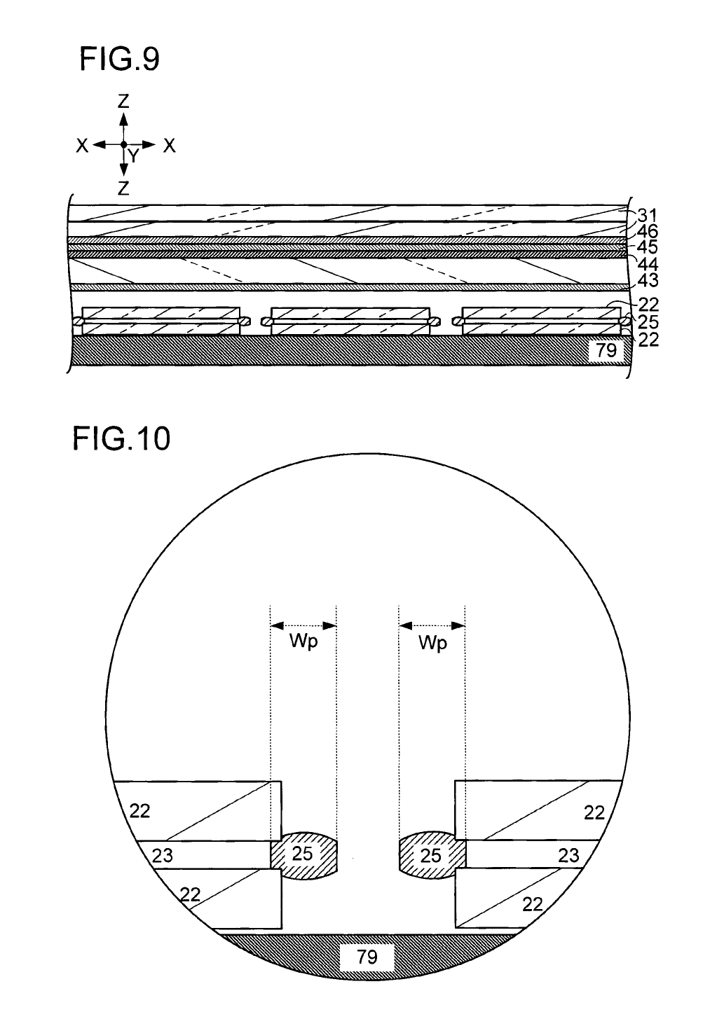

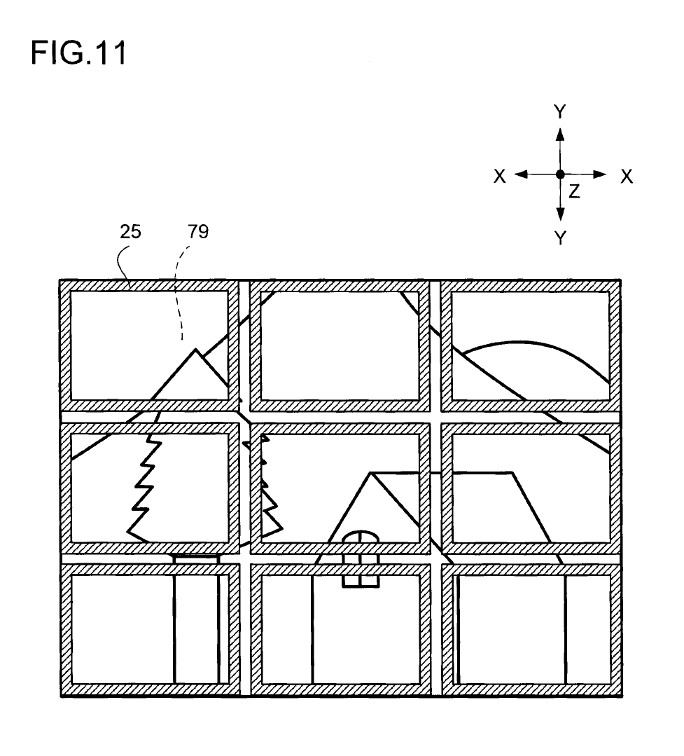

On the other hand, FIG. 9 is a sectional view showing a liquid crystal display device 69 that does not incorporate a light guide plate 11 (incidentally, taken and viewed in the same manner as FIG. 6), and FIG. 10 is an enlarged view of FIG. 9. And, FIG. 11 is a plan view showing the pattern plate 79 that is visible through the liquid crystal display panel 39 of the liquid crystal display device 69 shown in FIG. 9

As shown in FIGS. 9 and 10 illustrating comparative examples, in a case in which the liquid crystal display device 69 does not include a light guide plate 11 and includes a liquid crystal shutter unit 29, when the liquid crystal display panel 39 is switched to be a light transmission screen and the liquid crystal shutter unit 29 is OPEN, the pattern plate 79 is visible through the light transmission screen and the liquid crystal shutter unit 29 as shown in FIG. 11. As shown in FIG. 11, the sealing agents 25 located at the peripheries SD of the liquid crystal shutters 21 are visible through the light transmission screen of the liquid crystal display panel 39.

On the other hand, as shown in FIGS. 6 and 7, in a case in which the liquid crystal display device 69 includes a light guide plate 11 and also includes a liquid crystal shutter unit 29, when the liquid crystal display panel 39 is switched to be a light transmission screen and the liquid crystal shutter unit 29 is OPEN, the pattern plate 79 is visible through the light transmission screen and the liquid crystal shutter unit 29 as shown in FIG. 8. As shown in FIG. 8, although the sealing agents 25 located at the peripheries SD of the liquid crystal shutters 21 are visible through the light transmission screen of the liquid crystal display panel 39, the total area of the visible sealing agents 25 is reduced in comparison with the case shown in FIG. 11.

Normally, as in the comparative example shown in FIG. 10, if no light guide plate 11 is included in a liquid crystal display device 69, visible sealing agents have a width Wp. However, as shown in FIGS. 6 and 7, the liquid crystal display device 69 includes the light guide plate 11 that covers the sealing agents 25 with the curved surface CS included therein.

And, the curved surfaces CS are made of a light-transmitting resin, and thus refract light. Specifically, the curved surfaces CS refract light to converge the optical image of each of the sealing agents 25. As a result, as shown in FIG. 7, the sealing agents 25 appear to have a width Wr which is narrower than their actual width Wp. That is, the apparent width of the sealing agents 25 when a user sees the sealing agents 25 through the curved surfaces CS is narrowed down by the curved surfaces CS, such that the width of the sealing agents 25 looks narrower than their actual width Wp.

With this structure, the area of the sealing agents 25 visible in FIG. 8 is smaller than in FIG. 11. As a result, in contrast to the pattern plate 79 shown in FIG. 11 which is visually recognized as including borders (boundaries) attributable to the sealing agents 25, the pattern plate 79 shown in FIG. 8 is visually recognized as including no such borders (that is, visually recognized as seamless).

That is, as a result of the curved surfaces CS included in the light guide plate 11 covering the sealing agents 25, the optical images of the sealing agents 25 are seen through the curved surfaces CS as being smaller than the real sealing agents 25. This helps make the sealing agents 25 less noticeable externally. Thus, even with a liquid crystal display device 69 including a plurality of liquid crystal shutters 21, the image quality of the pattern plate 79 seen through the liquid crystal display panel 39 is not deteriorated.

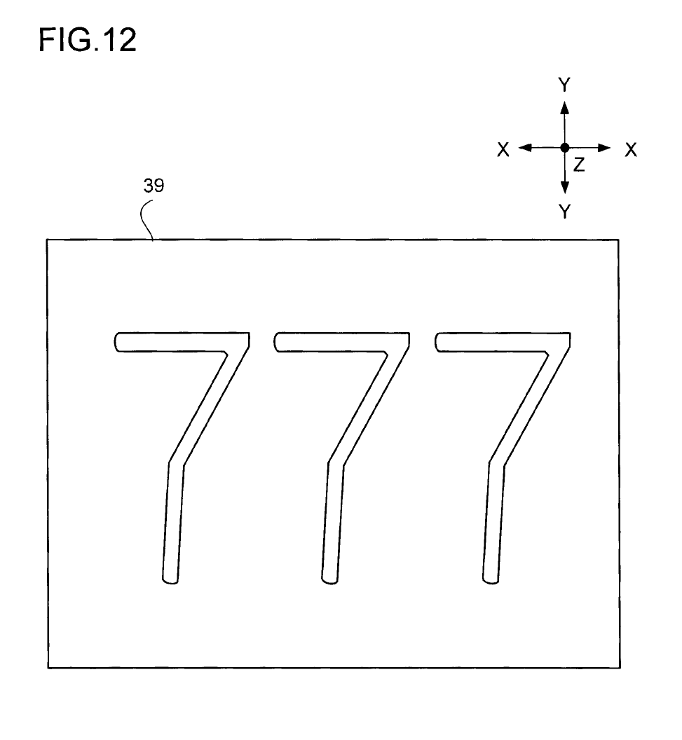

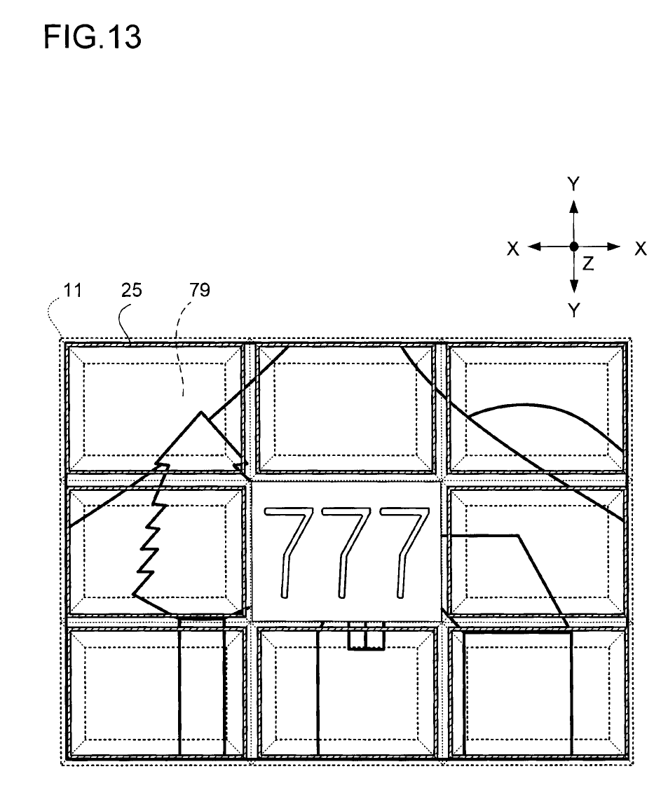

Incidentally, with a liquid crystal display device 69 including a plurality of liquid crystal shutters 21, it is possible to present various images by controlling the OPEN/CLOSE state of each of the liquid crystal shutters 21. For example, as shown in FIG. 12, with all the liquid crystal shutters 21 in the CLOSE state, an image “777” may be displayed all over the liquid crystal display panel 39, or as shown in FIG. 13, with only the central liquid crystal shutter 21 in the CLOSE state and the other liquid crystal shutters 21 in the OPEN state, the image “777” may be displayed only in the vicinity of the center of the liquid crystal display panel 39.

Incidentally, even in the case shown in FIG. 13, that is, in the case in which the image “777” is shown in the vicinity of the center of the liquid crystal display panel 39, and parts of the liquid crystal display panel 39 other than the vicinity of the center form a light transmission screen to thereby allow the pattern plate 79 to be visible through the light transmission screen, the sealing agents 25, which is visually recognized through the curved surfaces CS of the light guide plate 11, are made by the curved surfaces CS to look narrower, and thus are less noticeable.

Now, when the liquid crystal display panel 39 is switched to a light transmission screen, the image visible through the light transmission screen is not limited to the pattern plate 79. For example, another liquid crystal display module which is different from the liquid crystal display module 59 may be covered with the liquid crystal shutter unit 29 in place of the pattern plate 79.

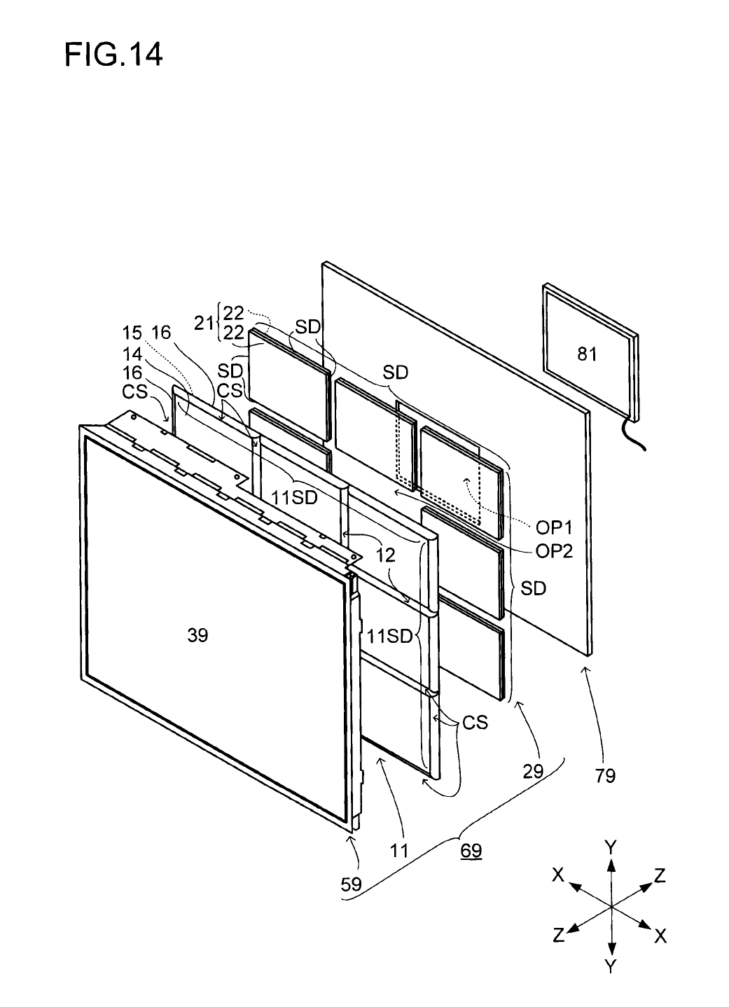

In addition, as shown in FIG. 14, in a case in which the pattern plate 79 has an opening OP1 formed in the center thereof, no liquid crystal shutter 21 needs to be provided in a region of the liquid crystal shutter unit 29 that overlaps the opening OP1. Thus, an opening (a void region) OP2 is formed in the center of the liquid crystal shutter unit 29 by arranging the liquid crystal shutters 21 around the opening OP2. Furthermore, since only the panel image is displayed at the center of the liquid crystal display panel 39 that overlaps the openings OP1 and OP2 via the light guide plate 11, a backlight unit (a light source) 81 may be arranged there to overlap the opening OP1 of the pattern plate 79.

That is, in the liquid crystal display device 69, the liquid crystal shutter unit 29 is formed to include the opening OP2 by arranging the liquid crystal shutters 21 leaving a void space corresponding to part of one surface of the light guide plate 11. And, the liquid crystal display device 69 includes the backlight unit 81 that supplies light through the opening OP2 to the liquid crystal display module 59.

With this structure, light from the backlight unit 81 reaches the liquid crystal display panel 39 through the opening OP1 of the pattern plate 79 and the opening OP2 of the liquid crystal shutter unit 29. This helps further increase the brightness of an image displayed on the liquid crystal display panel 39, which makes it possible to realize clear image display.

Incidentally, cost of a liquid crystal shutter unit 29 formed as one piece of plate would be comparatively high. In contrast, the above described liquid crystal shutter unit 29 is formed of a plurality of liquid crystal shutters 21, and thus the cost is comparatively low. Thus, the liquid crystal display device 69 incorporating the liquid crystal shutter unit 29 is also comparatively low in cost.

### Other Embodiments

It should be understood that the embodiments specifically described above are not meant to limit the present invention, and that many variations and modifications can be made within the spirit of the present invention.

For example, the light guide plate 11 may be formed as one piece or as an assembly of flat light guide pieces. Also, although there is a space between any adjacent ones of the liquid crystal shutters 21 in the liquid crystal shutter unit 29, the liquid crystal shutters 21 may be in close touch with each other.

In addition, in the liquid crystal display device 69 shown in FIG. 1, the light guide plate 11 is placed between the liquid crystal display module 59 and the liquid crystal shutter unit 29. However, this is not meant to limit how these components (the light guide plate 11, the liquid crystal display module 59, and the liquid crystal shutter unit 29) should be arranged.

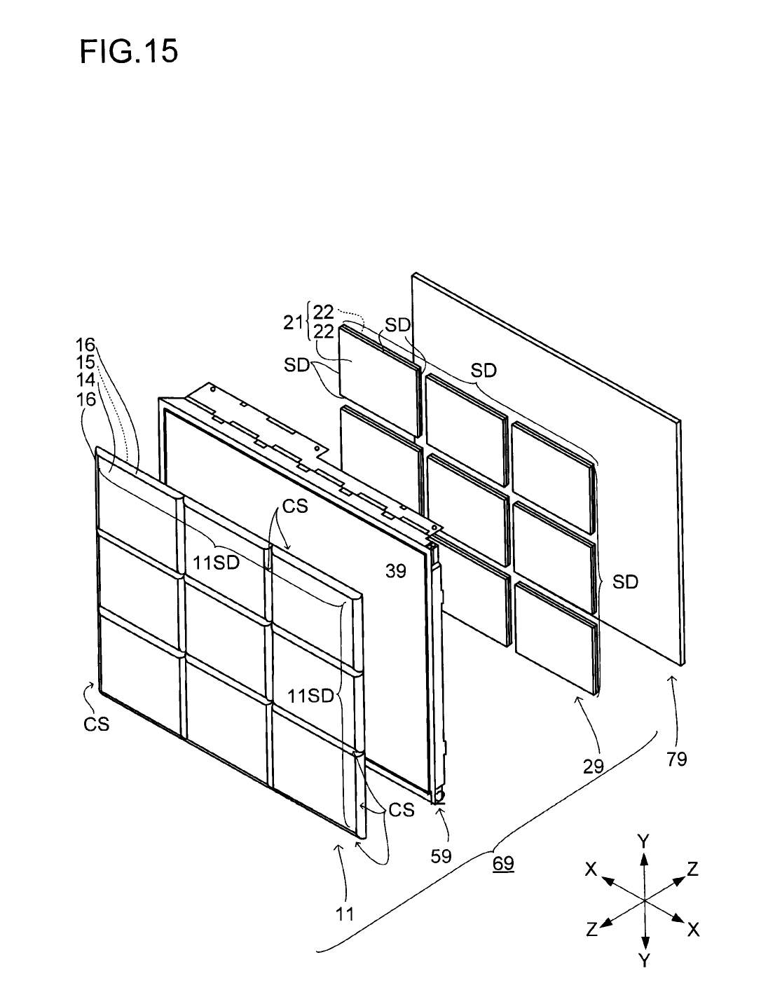

For example, as shown in FIG. 15, the light guide plate 11 may cover the liquid crystal display module 59 that covers the liquid crystal shutter unit 29. That is, the light guide plate 11, the liquid crystal display module 59, and the liquid crystal shutter unit 29 may be arranged to overlap one another in this order (incidentally, in a game device incorporating the liquid crystal display device 69 having this arrangement, the pattern plate 79 is covered with the liquid crystal shutter unit 29 in the same manner as in the liquid crystal display device 69 shown in FIG. 1).

In the liquid crystal display device 69 having this arrangement, light from the fluorescent tube 41 incorporated in the liquid crystal display module 59 is prevented from easily entering the light guide plate 11. Specifically, as shown in FIG. 3, light from the fluorescent tube 41 has to pass through the light guide plate 42, the optical sheet group 47, and the liquid crystal display panel 39 before reaching the light guide plate 11. As a result, unwanted irregular reflection is prevented from occurring in the light guide plate 11. This helps reduce unevenness in display caused by irregular reflection in the light guide plate 11.

### LIST OF REFERENCE SYMBOLS

11 light guide plate (light transmitting substrate)
12 cut formed in light guide plate
13 inner surface of cut
14 top surface of light guide plate
15 bottom surface of light guide plate
16 side surface of light guide plate
CS curved surface included in light guide plate
21 liquid crystal shutter
22 transparent substrate
23 liquid crystal layer
25 sealing agent
29 liquid crystal shutter unit
SD periphery of liquid crystal shutter, periphery of liquid crystal shutter unit
31 transparent substrate
39 liquid crystal display panel
41 fluorescent tube
42 light guide plate incorporated in liquid crystal display module
43 reflection sheet
47 optical sheet group
49 backlight unit
59 liquid crystal display module
69 liquid crystal display device
79 pattern plate (pattern portion)
81 backlight unit (light source)

1. A liquid crystal display device, comprising:
a liquid crystal display module which is not only capable of displaying an image but also switchable to a light transmission screen; and
a liquid crystal shutter unit which switches between states for allowing and blocking external visibility through the light transmission screen,
wherein
the liquid crystal shutter unit is an assembly formed planar by arranging a plurality of liquid crystal shutters in a plane, the liquid crystal shutters each having liquid crystal sealed therein with a sealing agent;
at one surface side of the liquid crystal shutter unit which is planar, a light transmitting substrate is arranged to overlap the liquid crystal shutter unit; and
in the light transmitting substrate, at a portion thereof overlapping the sealing agent which is located at a periphery of each of the liquid crystal shutters, there is formed a curved surface that makes the sealing agent look narrower than the sealing agent actually is when the sealing agent is seen through the curved surface.

2. The liquid crystal display device of claim 1,
wherein
the light transmitting substrate is placed between the liquid crystal display module and the liquid crystal shutter unit.

3. The liquid crystal display device of claim 1,
wherein
the light transmitting substrate covers the liquid crystal display module that covers the liquid crystal shutter unit.

4. The liquid crystal display device of claim 1,
wherein
the liquid crystal shutter unit includes a void region formed by arranging the liquid crystal shutters leaving a void space corresponding to part of one surface of the light transmitting substrate; and
there is further included a light source that supplies light to the liquid crystal display module through the void space.

5. A game device, comprising:
the liquid crystal display device of claim 1; and
a pattern portion that is externally visible through the liquid crystal display module and the liquid crystal shutter unit when the liquid crystal display module is switched to be the light transmission screen and the liquid crystal shutter unit obtains external visibility.

6. A game device, comprising:
the liquid crystal display device of claim 2; and
a pattern portion that is externally visible through the liquid crystal display module and the liquid crystal shutter unit when the liquid crystal display module is switched to be the light transmission screen and the liquid crystal shutter unit obtains external visibility.

7. A game device, comprising:
the liquid crystal display device of claim 3; and
a pattern portion that is externally visible through the liquid crystal display module and the liquid crystal shutter unit when the liquid crystal display module is switched to be the light transmission screen and the liquid crystal shutter unit obtains external visibility.

8. A game device, comprising:
the liquid crystal display device of claim 4; and
a pattern portion that is externally visible through the liquid crystal display module and the liquid crystal shutter unit when the liquid crystal display module is switched to be the light transmission screen and the liquid crystal shutter unit obtains external visibility.
